(19) United States
(12) Patent Application Publication
(10) Pub. No.: US 2024/0199853 A1
(43) Pub. Date: Jun. 20, 2024

(54) SILICATE BASED THICKENER COMPOSITION

(71) Applicant: BYK-Chemie GmbH, Wesel (DE)

(72) Inventors: Klaus Dziwok, Freilassing (DE); René Nagelsdiek, Hamminkeln (DE); Sylvia Bühne, Wesel (DE); Christian Sauerländer, Oberhausen (DE); Jasmin Muellemann, Dinslaken (DE)

(21) Appl. No.: 18/555,743

(22) PCT Filed: Apr. 26, 2022
(86) PCT No.: PCT/EP2022/061014

§ 371 Date: Oct. 17, 2023

(30) Foreign Application Priority Data
Apr. 27, 2021 (EP) 21170682.5

(51) Int. Cl. C08K 9/04; C08F 222/10; C08K 3/34; C08K 3/36; C08K 5/17; C09D 7/43

(52) U.S. Cl. CPC C08K 9/04; C08F 222/102; C08K 3/346; C08K 3/36; C08K 5/17; C09D 7/43

(57) ABSTRACT

The invention relates to a composition comprising a) a silicate, and b) a compound B) having a molecular weight of at least 200 g/mol and comprising at least two groups selected from secondary amine, tertiary amine, salt of secondary or tertiary amine, and quaternary ammonium, and wherein compound B) includes at least one ester group.

The invention relates to a composition comprising a silicate and an amine compound, to an aqueous liquid composition comprising the composition, to a process of coating a substrate, and to the use of an amine compound for improving the thickening effect of a silicate in an aqueous composition.

In the field of aqueous coating materials, adhesives, sealants, and molding compounds, as well as aqueous drilling fluids, formulations used in construction, formulations used for homecare, cleaners, personal care and the like, it is necessary to customize the rheological properties of such liquid systems, primarily through adjusting the viscosity. This can be done by the selection of binding agents, (co-)solvents and the concentration of pigments and/or fillers. Often, the addition of so-called rheology additives to these liquids is required. The effect of these additives resides in adjusting the rheological properties of the system, like the viscosity and the viscoelastic properties. By doing so, the system properties are usually improved with respect to sag resistance, improved storage stability (due to reduced settling of solid particles), or a general increase in viscosity, often referred to as “thickening”.

It is known to use silicate materials as rheology control agents in aqueous liquid compositions. The thickening effect of such rheology control agents can be increased by low molecular weight polyamines. WO 91/07468 describes the use of polyalkylene polyamines to increase the viscosity of aqueous clay slurries. Examples of suitable amines include ethylenediamine, diethylenetriamine, piperazine, propylene diamine, and the like. However, such amines are considered problematic in view of occupational safety and industrial hygiene.

U.S. Pat. No. 5,972,263 describes the treatment of clay compositions with polyethylene amines and polyethylene imines for improving the plasticity of the clay compositions. The use of such compounds can improve the rheological effectiveness of clays. However, such compounds cause incompatibilities in many aqueous coating compositions. This makes them less suitable for improving the thickening effect of silicates in aqueous compositions.

There is a need for silicate compositions having improved rheological effectiveness and which are free of or alleviate the above-mentioned drawbacks.

The invention provides a composition comprising
a) a silicate, and
b) a compound B) having a molecular weight of at least 200 g/mol and comprising at least two groups selected from secondary amine, tertiary amine, salt of secondary or tertiary amine, and quaternary ammonium, and wherein compound B) includes at least one ester group.

The composition of the invention provides improved rheological effectiveness, in particular in aqueous liquid compositions. The composition exhibits a good compatibility with most aqueous coating composition and has acceptable properties in view of occupational safety and industrial hygiene. The composition allows the use of a lower amount of silica to achieve a desired thickening effect than without the presence of compound B). Alternatively, while keeping the same amount of silica, a significantly improved rheological performance can be achieved.

As mentioned above, the composition comprises a silicate. Generally, the silicate comprises at least one of synthetic clay, natural clay, and silica.

Suitable synthetic or natural clays include kaolins, smectites, illite, chlorites or other 2:1 clay types. In particular, the clays are selected from montmorillonite, bentonite, beidellite, mica, hectorite, saponite, nontronite, sauconite, vermiculite, ledikite, magatite, kenyaite, stevensite, volkonskoite, hydrotalcite, illite, kaolinite, wollastonite, attapulgite, sepiolite, and halloysite. In some embodiments, smectites are preferred. Suitable synthetic or natural clays are commercially available from BYK, for example under the trade designations Laponite®, Optigel®, Bentolite®, Optibent®, or Cloisite®.

Suitable types of silica include colloidal silica, precipitated silica, and fumed silica. In preferred embodiments, silica comprises fumed silica. Fumed silica is also known as pyrogenic silica. Fumed silica is commercially available from different manufacturers, for example from Evonik under the trade designation Aerosil, from the Cabot Corporation under the trade designation Cab-O-Sil, as well as from Wacker, Dow Corning, Heraeus, and Tokuyama Corporation.

It is generally preferred that the silicates mentioned above are present as inorganic or substantially materials, which have not been modified by treatment with organic compounds, such as treatment with hydrophobic agents or organic ion exchange agents, such as quaternary ammonium compounds.

The composition further comprises a compound B) having a molecular weight of at least 200 g/mol and comprising at least two groups selected from secondary amine, tertiary amine, salt of secondary or tertiary amine, and quaternary ammonium, and wherein compound B) includes at least one ester group.

Compound B and the silicate are not linked by covalent bonds.

Generally, the molecular weight of compound B) is in the range of 200 g/mol to 4000 g/mol. Preferably, the molecular weight of compound B) is at least 300 g/mol. In preferred embodiments, the molecular weight of compound B) is in the range of 300 g/mol to 3000 g/mol, or in the range of 350 g/mol to 3000 g/mol. The molecular weight can suitably be determined by gel permeation chromatography. If compound B) has a molecular weight distribution, the mentioned molecular weights refer to the number average molecular weight Mn, determined by gel permeation chromatography using THF (containing 1 vol. % dibutyl amine) as eluent and calibration with a polystyrene standard. In some embodiments, it is preferred that compound B) has a molecular weight distribution, i.e. Mw/Mn is larger than 1.00.

Compound B) preferably has a low content of ethylenically unsaturated groups. Hence, in some embodiments compound B) is free or essentially free of ethylenically unsaturated groups. Generally, compound B) comprises ethylenically unsaturated groups in an amount of 0.0 mmol/g to 2.0 mmol/g, preferably 0.0 mmol/g to 0.1 mmol/g. The presence of ethylenically unsaturated groups in compound B) in higher amounts may detract from the stability of the composition and impair the compatibility with curing reactions in coating compositions.

Compound B) comprises at least two groups selected from secondary amine, tertiary amine, salt of secondary or tertiary amine, and quaternary ammonium.

In preferred embodiments, compound B) comprises at least two groups selected from secondary amine and tertiary amine or salts thereof, and is substantially free or free of quaternary ammonium groups.

In a preferred embodiment, compound B) comprises at least one secondary amine group and at least one tertiary amine group.

In some embodiments, compound B) comprises at least one secondary or tertiary amine group and comprises at least one further group selected from primary amine, secondary amine, and tertiary amine. In a further embodiment, compound B) comprises at least one secondary or tertiary amine group and comprises further at least one tertiary amine group. In a further embodiment, compound B) further comprises at least one hydroxyl group.

In embodiments wherein compound B) comprises a secondary amine group and a tertiary amine group, it is preferred that the two amino group nitrogen atoms are covalently linked to each other via an organic group having 2 or 3 carbon atoms. It is highly preferred that the groups named are covalently linked to each other via an ethylene or a propylene group.

In a preferred embodiment, compound B) comprises two tertiary amine groups.

In a further preferred embodiment, compound B) comprises two secondary amine groups and two tertiary amine groups.

In a further preferred embodiment, compound B) comprises two secondary amine groups and more than two tertiary amine groups. In yet another preferred embodiment, compound B) comprises two secondary amine groups and at least four tertiary amine groups.

Compound B) comprises at least one ester group. In a preferred embodiment, compound B) comprises at least two ester groups. In other embodiments, compound B) comprises 3 or 4 ester groups. In typical embodiments, the number of ester groups is equal to the number of secondary amine groups in compound B). In preferred embodiments, the number of ester groups is higher than the number of secondary amine groups.

In some embodiments, compound B) is represented by the following formula (I)

R¹—(—O—(C═O)—CR²R³—CR⁴R⁵—NR⁶R⁷ (I)

wherein R¹ represents an organic group having 2 to 300 carbon atoms, preferably 4 to 200 carbon atoms, more preferably 6 to 150 carbon atoms, such as 10 to 100 carbon atoms.

R², R³, R⁴, and R⁵ independent of each other represent hydrogen or an alkyl group having 1 to 6 carbon atoms, with the proviso that at least one of R², R³, R⁴, and R⁵ is hydrogen,
R⁶ and R⁷ independently of each other represent hydrogen or an organic group, wherein at least one of R⁶ and R⁷ is not hydrogen, and wherein at least one of R¹, R⁶, and R⁷ comprise at least one group selected from secondary amine, tertiary amine, salt of secondary or tertiary amine, and quaternary ammonium.

In a preferred embodiment, at least two of R², R³, R⁴, and R⁵ represent hydrogen. In a more preferred embodiment, at least three of R², R³, R⁴, and R⁵ represent hydrogen. In a very preferred embodiment, all of R², R³, R⁴, and R⁵ represent hydrogen. 5 In a preferred embodiment, at least one of R⁶ and R⁷ represents an organic group which comprises at least one amine or one hydroxy group. In a more preferred embodiment, at least one of R⁶ and R⁷ represents an aliphatic organic group which comprises at least one amine or one hydroxy group. In one embodiment, at least one of R⁶ and R⁷ represents an organic group which comprises at least one amine or one hydroxy group and at least one ester group. 10 In a preferred embodiment, R⁷ represents hydrogen or an organic group which comprises at least two ester groups while R⁶ represents an organic group which contains 4 to 20 carbon atoms and no ester groups. In a more preferred embodiment, R⁷ represents hydrogen or an organic group which comprises at least two ester groups while R⁶ represents an organic group which consists only of atoms selected from carbon, hydrogen, oxygen and nitrogen, very preferably only of atoms selected from carbon, hydrogen, and nitrogen. In an even more preferred embodiment, R⁷ represents hydrogen or an organic group which comprises at least two ester groups while R⁶ represents an aliphatic organic group which contains 4 to 12 carbon atoms, such as 4 to 10 carbon atoms or 5 to 8 carbon atoms.

In preferred embodiments, R¹ comprises a hydrocarbyl group and a further group of the formula (II)

—(—O—(C═O)—CR²R³—CR⁴R⁵—NR⁶R⁷ (II),

wherein R², R³, R⁴, R⁵, R⁶, and R⁷ are defined as above.

Generally, compound B) has an amine value in the range of 50 to 700 mg KOH/g. Preferably, the amine value of compound B) is in the range of 70 to 650 mg KOH/g, more preferably in the range of 100 to 600 mg KOH/g and most preferably in the range of 150 to 550 mg KOH/g. The amine value is the amount KOH in mg which corresponds to the amine content of 1 g of substance. The amine values may be determined according to DIN 16945 by potentiometric titration with 0.1 N perchloric acid in acetic acid. Amine values may be calculated based on raw materials used or determined by titration.

Compound B) described above can be prepared by an addition reaction of a primary or secondary amine group-containing compound to a compound having at least one Michael-acceptor group. A Michael-acceptor group is an electron depleted ethylenically unsaturated group which is susceptible to addition of a nucleophilic agent. Examples of suitable Michael-acceptor groups are the double bonds of α,β-unsaturated carboxylic acid esters.

In preferred embodiments, compound B) may be prepared by reaction of a compound having at least two acrylate-functional groups with a compound having a primary or secondary amine group, wherein the primary or secondary amine is employed in such a molar amount to assure that essentially all acrylate groups are reacted Generally, when 1.00 mol of acrylate groups is reacted with a primary amine, between about 0.40 and 1.10 mol of primary amino groups are employed, preferably between 0.75 and 1.05 mol. When 1.00 mol of acrylate groups is reacted with a secondary amine, between about 0.90 and 1.10, preferably between 0.95 and 1.05 mol of secondary amino groups are employed.

Instead of a compound having at least two acrylate-functional groups, it is also possible to use a compound having at least two groups selected from maleate, fumarate, and itaconate functional groups, for example an unsaturated polyester based on maleic anhydride (or maleic acid), fumaric acid, itaconic acid, and mixtures thereof. In another embodiment, it is also possible to use a compound having at least one acrylate group and least one group selected from maleate, fumarate, and itaconate functional groups,

Examples of suitable starting materials to prepare the additive agents are diacrylates of diols. Preferred diacrylates are diacrylates of C₂ to C₂₄ hydrocarbyl diols, preferably C₃ to C₁₈ hydrocarbyl diols, more preferably C₄ to C₁₂ hydrocarbyl diols, such as C₅ to C₈ hydrocarbyl diols. Preferably, the hydrocarbyl diols are alkylene diols. These diols can be linear or branched. Suitable diols are simple aliphatic diols, such as 1,6-hexane diol or neopentyl glycol.

Further preferred diacrylates are diacrylates of diols derived from oligo- or poly alkylene oxides, such as polyethyleneglycol, polypropyleneglycol, polybutyleneglycol, poly(THF), or copolymers of ethylene oxide and/or propylene oxide and/or butylene oxide.

Diacrylates of diols based on a hydrocarbyl diol, preferably an alkylene diol, are particularly preferred.

Acrylic acid esters of alcohols having more than two hydroxyl groups are suitable as well, for example trimethylol propane, glycerol, pentaerythritol, ditrimethylol propane, or dipentaerythritol, as well as alkoxylated derivatives thereof.

Further examples include polyester di- or tri- or polyfunctional acrylates based on a polyester backbone terminated by acrylic acid ester groups. Alternatively, it is possible to use so-called epoxy acrylates, which can be prepared by addition of acrylic acid to epoxide functional precursors. Examples of suitable epoxide functional precursors are epoxidized natural oils, aromatic or aliphatic glycidylethers, and epoxide functional polymers, for example copolymers of glycidyl methacrylate obtained by polymerization of its double-bond.

It also possible to use urethane acrylates, which can be prepared by reaction of hydroxyl-functional acrylate esters with aliphatic or aromatic isocyanates having two or more isocyanate groups.

The primary or secondary amine which may be added to a Michael-acceptor group in the above-described reactions is generally a primary or secondary amine having a molecular weight in the range of 31 to about 1200 g/mol, more preferably of 45 to about 500 g/mol, even more preferably of 59 to about 300 g/mol. Aliphatic amines and arylaliphatic amines are preferred.

In some embodiments, the primary or secondary amine has further functional groups. Examples of suitable further functional groups are hydroxyl groups, tertiary amine groups, ammonium groups, and thiol groups. So far, very good results have been obtained in embodiments wherein the further functional group is a tertiary amine group or a hydroxyl group. Examples of suitable amine starting materials include primary and secondary aliphatic or arylaliphatic monoamines and diamines. Very good results have been obtained with aliphatic primary and secondary amines having an additional tertiary amine group or an additional hydroxyl group.

Therefore, preferred amine starting materials are aminoethanol, 1-aminopropan-2-ol, 1-aminopropan-3-ol, aminobutanol, aminopentanol, aminohexanol, 2-amino-2-(hydroxymethyl)propan-1,3-diol, dihydroxydiethylamin, 2-ethyl-2-aminopropanediol, D-glucamine, N-Methyl-D-glucamine, 1-(3-aminopropyl)imidazole, N,N-dimethyl-1,3-diaminopropane, 3-(Methylamino)propylamine, N,N,N″,N″-tetramethyldipropylenetriamine, N,N-diethylethylenediamine, and 1-methylpiperazine.

In some embodiments compound B) is prepared by an addition reaction of a primary or secondary amine having a further functional group which is a primary or secondary amine group. If a molecule having one or more primary amine groups is used in such reactions, it is sometimes preferred to use a molar excess of primary amine groups over Michael acceptor groups.

Preferred amine starting materials being di-primary amines are ethylene diamine, 1,2-diamino propane, 1,3-diaminopropane, 1,4-diaminobutane, 1,5-diaminopentane, 1,6-diaminohexane.

A preferred amine starting material being an amine with more than two primary amine groups is 2,2′,2″-triaminotriethylamine.

Preferred amine starting materials having two or more amino groups of which at least one is a secondary amino group are triazacyclononane, piperazine, 2-methylpiperazine, N,N′-diethylethylendiamine, N,N-dimethylamino ethyl-piperazine, and 3-(methylamino)propylamine, bis-(2-aminoethyl) amine, triethylene tetramine, and tetraethylene pentamine.

In some embodiments, compound B) comprises an amine salt or a quaternary ammonium group. As known to someone skilled in the art, amine salts can be obtained by partial or complete neutralization of an amine using a Brönstedt acid; this acid can be both an organic or an inorganic acid. Quaternary ammonium groups can be obtained by treating a tertiary amine with an alkylating agent.

The addition reaction of primary amine groups to Michael-acceptor groups, such as acrylate groups, leads to secondary amine groups. Such secondary amine groups can undergo a further addition to a Michael-acceptor group of the same or of a different molecule. If this happens, the molecular weight of the reaction products increases, and generally the molecular weight distribution will be broadened.

In typical embodiments, compound B) is represented by formula (III)

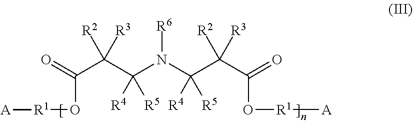

wherein at least 50 to 100 mol-% of the groups A represent a group of the formula

—(—O—(C═O)—CR²R³—CR⁴R⁵—NR⁶R⁷, (II)

Wherein R¹, R², R³, R⁴, R⁵, R⁶, and R⁷ are defined as above, and
n is an integer in the range of 1 to 15, preferably 1 to 10, such as 1 to 7.

If specific groups occur more than once in a given molecule, they can be selected independently of each other for every occurrence.

In a preferred embodiment, the group R¹ of formula (III) is representing a hydrocarbyl group containing 2 to 24 carbon atoms, preferably 3 to 18 carbon atoms, more preferably 4 to 12 carbon atoms, most preferably 5 to 8 carbon atoms. It is preferred that R¹ is an aliphatic group which can be saturated or unsaturated, linear or branched. It is preferred that R¹ is a saturated group. In one embodiment, R¹ is representing an alkylene group.

In preferred embodiments, at least 70 mol-%, more preferably at least 85 mol-% of the groups A represent a group of formula (II).

When less than 100 mol-% of the groups A are groups of the formula (II), the remaining groups A represent an ethylenically unsaturated polymerizable group, preferably an acrylate or methacrylate group.

In the composition of the invention, the weight ratio of silicate and compound B) can vary in wide ranges. However, generally the amount of compound B) does not exceed the amount of silicate. In preferred embodiments, compound B) is present in an amount of 3.0 to 100.0% by weight, preferably 5.0 to 60.0% by weight, calculated on the weight of the silicate. In the most preferred embodiment, compound B) is present in an amount of 7.0 to 50.0% by weight, such as 8.0 to 40.0% by weight, calculated on the weight of the silicate.

The composition of the invention is very suitable as a rheology control additive for liquid compositions, preferably for aqueous liquid compositions. Therefore, the invention also relates to an aqueous liquid composition comprising the composition according to the invention as described above.

The term “liquid composition” denotes a composition, i.e. a matter of at least two substances, being liquid at 23° C. and 100 kPa. Within the current invention, the term liquid refers to any liquid medium, independent of its viscosity. Liquids therefore comprise very low viscous media as well as high viscous media, such as paste materials.

A liquid composition is defined as an aqueous composition when at least 50% by weight of all volatile liquid in the composition is water. Preferably, 50 to 100% by weight of all volatile liquid in the composition is water, more preferably 70 to 100% by weight of all volatile liquid in the composition is water, such as 80 to 100%, 90 to 100%, or 95 to 100% by weight of all volatile liquid in the composition. Volatile liquids are defined as liquids having a boiling point at 100 kPa of 250° C. or less.

Examples of suitable aqueous liquid compositions are: a coating composition, a plastic formulation, a pigment paste, a polymer formulation, a sealant formulation, a cosmetic formulation, a homecare or industrial care formulation (including perfume and fragrance formulations), a ceramic formulation, a flooring formulation, an adhesive formulation, a liquid formulation for use in gas and oil production, a composition for the manufacture of electrical components and circuits, a liquid formulation for use in energy storage media, a cleaning agent, a potting compound, a building material formulation, a lubricant, a filling compound, a wax emulsion, a metalworking fluid, a metal-processing product, a liquid composition in the form of a spraying agent, a so-called deposition aid (e.g., for use in plant protection agents or for the general purpose of drift reduction), an ink, and mixtures thereof.

Further aqueous liquid compositions wherein the composition according to the present invention can be used are aqueous paints (such as marine and protective coatings, automotive coatings, general industrial coatings, can and coil coatings, decorative paints, and wall paints), printing inks and inks and lacquers as e.g. lacquers for varnishing of plastics, wire enamels, floor coatings, coating compositions for coating foodstuffs and seeds, and as so-called color resists, which are used for color filters, for example in flat panel displays such as liquid-crystal displays. The field of application lacquers also includes pasty materials which generally have a very high proportion of solids and a small proportion of liquid components, for example so-called pigment pastes or also pastes based on effect pigments, for example metal effect pigments such as, for example, aluminum pigments, silver pigments, brass pigments, zinc pigments, copper pigments, bronze pigments such as gold bronzes, fire-dyed bronzes or iron oxide aluminum pigments. The effect pigments also include, for example, interference pigments or pearlescent pigments such as, for example, metal oxide mica pigments, fishsilver, bismuth oxide chloride or basic lead carbonate.

The cosmetic preparations can be various liquid compositions, which are used in the so called personal care or healthcare sector, e.g. lotions, creams, pastes such as, for example, toothpaste, foams such as, for example, shaving foam, gels such as, for example, shaving gels, shower gels or active ingredients in gel formulations, hair shampoos, liquid soaps, nail varnishes, lipsticks and hair dyes. The so-called wax emulsions are preferably dispersions of solid waxes in particulate form at room temperature in an aqueous medium. The building material formulations may be liquid or paste-like materials, which are used in the construction sector and solidify after curing, such as concrete, mortar, putty, plaster, tile adhesives, cementitious materials, and gypsum-based materials. The metal working fluids may be cutting liquids, drilling fluids (such as are used in metal processing), or forging fluids or lubricants in general. Potential other areas are release agents (for example, aluminum die casting and foundry applications), foundry washes (foundry coatings) and liquids for the surface treatment of metals. The lubricants are means, which are used for lubrication, that is to say, which serve to reduce friction and wear, as well as to provide power, cooling, vibration dampening, sealing action and corrosion protection. Cleaning agents can be used to clean a wide range of objects, for example in the area of homecare or industrial care. They effect or assist the removal of impurities, residues and attachments. The cleaners also include detergents (primarily for cleaning textiles, their precursors, leather, and dish), and personal care products. Formulations containing perfumes and other fragrances (either as liquid raw materials or in encapsulated form), e.g., as perfume gels, also belong to this area of application.

The adhesives can be all adhesive materials which are liquid under processing conditions and which can join parts by surface adhesion and internal strength. The sealants (including caulks) can be all materials which are liquid under processing conditions and which can work as a mechanical seal, preferably to block the passage of fluids, gases, or particles (e.g., dust), as well as the transmission of sound and/or temperature through surface, joints or openings in materials.

Liquid formulations used for gas and oil production are formulations used to develop and exploit a deposit. Drilling fluids or “drilling muds” are preferred examples. Another application example are liquids used to prepare or perform a hydraulic fracturing process.

The aqueous liquid composition of the invention may further comprise customary additives. Examples of additives are antiblocking agents, stabilizers, antioxidants, pigments, wetting agents, dispersants, emulsifiers, additional rheology additives, UV absorbers, free-radical scavengers, slip additives, defoamers, adhesion promoters, leveling agents, waxes, nanoparticles, film-forming auxiliaries, and flame retardants. Preferred additives are wetting agents, dispersants and/or emulsifiers and rheology additives, which are different from the composition of the present invention.

Preferably, the aqueous liquid composition is essentially free from volatile organic solvents. That denotes a composition suitably comprising between 0.0 and less than 15.0%, preferably less than 10.0% by weight of volatile organic solvent, more preferably between 0.0 and 7.0% by weight of volatile organic solvent, calculated on the total weight of the non-aqueous liquid composition. More preferably, the aqueous liquid composition comprises less than 5.0% by weight of volatile organic solvent.

The aqueous liquid composition may suitably further comprise a film-forming binder. The film-forming binder is different from the compound B). The film-forming binder may be dissolved in the aqueous phase of the aqueous liquid composition. In an alternative embodiment, the film-forming binder is present in the form of dispersed droplets or particles in the aqueous phase.

The film-forming binder may be any of those known as suitable for aqueous compositions.

In typical embodiments, the film-forming binder comprises at least one of polyacrylate, copolymer of styrene, polyvinylester, polyurethane, polyester, polyunsaturated resin, and epoxide resin.

Polyacrylates are polymers and copolymers of esters or amides of acrylic and methacrylic acid, optionally in combination with other ethylenically unsaturated polymerizable monomers. Polyvinylesters are polymers and copoloymers of vinyl esters, such as vinyl acetate or vinyl butyrate, as well as copolymers with other unsaturated monomers.

In a preferred embodiment, the aqueous liquid composition comprises a silicate in the range of 0.10 to 7.00% by weight, calculated on the weight of the aqueous liquid composition.

The aqueous liquid composition suitably comprises
i) 0.10 to 37.00% by weight of a silicate
ii) 0.01 to 37.00% by weight of compound B)
iii) 25.00 to 99.89% by weight of a film-forming binder,
calculated on the sum of the weight of components i), ii) and iii). The film-forming binder iii) encompasses a resin used, as well as all components able to form covalent bonds with the resin, such as hardeners and reactive diluents.

Preferably, the aqueous liquid composition comprises
i) 0.20 to 31.00% by weight of a silicate
ii) 0.02 to 31.00% by weight of compound B)
iii) 38.00 to 99.78% by weight of a film-forming binder),
calculated on the sum of the weight of components i), ii) and iii).

More preferably, the aqueous liquid composition comprises
i) 0.30 to 29.00% by weight of a silicate
ii) 0.03 to 29.00% by weight of compound B)
iii) 42.00 to 99.67% by weight of a film-forming binder,
calculated on the sum of the weight of components i), ii) and iii).

In one embodiment, the aqueous liquid composition described above is formulated as a coating composition. Therefore, the invention further relates to process of coating a substrate with at least one coating layer, comprising applying the said coating composition to a substrate.

As mentioned above, the rheological effectiveness of a silicate in an aqueous composition is improved by the compound B). Therefore, the invention further relates to the use of a compound B) having a molecular weight of at least 200 g/mol and comprising at least two groups selected from secondary amine, tertiary amine, salt of secondary or tertiary amine, and quaternary ammonium, and wherein compound B) includes at least one ester group, for improving the rheological effectiveness of a silicate in an aqueous composition.

The invention further relates to a method of improving the rheological effectiveness of a silicate in an aqueous composition, comprising including in the composition a compound B) having a molecular weight of at least 200 g/mol and comprising at least two groups selected from secondary amine, tertiary amine, salt of secondary or tertiary amine, and quaternary ammonium, and wherein compound B) includes at least one ester group.

Rheological effectiveness means the variation of the viscosity or viscoelastic properties according to the intended use. Generally, the composition of silicate and compound B) is employed to increase the viscosity of an aqueous liquid composition, which leads to a thickening effect and an increase in anti-sag behavior.

The silicate is generally a solid. The compound B) may be a solid or a liquid. The compound B) may be liquid as such or being dissolved in an appropriate organic solvent. The solvent can be any kind of organic solvent which is capable of dissolving compound B). Preferably, the solvent is soluble or dispersible in water; it is furthermore preferred that the solvent is non-toxic and has an ecologically beneficial profile. In preferred embodiments, the solvent is a non-volatile liquid having a boiling point of 250° C. or higher at atmospheric pressure. Particularly preferred as solvent are polymers and oligomers of alkylene oxides, such as ethylene oxide and/or propylene oxide. These can be homopolymers like polyethyleneglycol or polypropyleneglycol, but also random and block copolymers. In some embodiments, the polymers or oligomers of ethylene oxide and/or propylene oxide have one or two ether end groups, in particular alkyl ether end groups, wherein the alkyl groups have 1 to 18 carbon atoms, preferably 1 to 4 carbon atoms. In other embodiments, the polymers or oligomers of ethylene oxide and/or propylene oxide have two hydroxy end groups. The number average molecular weight of these oligomeric or polymeric solvents is generally in the range of 170 to 1000 g/mol, preferably 200 to 800 g/mol.

The silicate and the compound B) may suitably be added to an aqueous liquid composition, either simultaneously or subsequently. In one preferred embodiment, the silicate and the compound B) are mixed prior to their addition to an aqueous liquid composition. The mixing process can be provided by any mixing equipment known in the state of the art, such as all kind of mills or extruders. In a different embodiment, the compound B) may be premixed with an adsorbing agent, which is different from the silicate, prior to the mixture of the compound B) with the silicate. In a further embodiment, compound B) may be provided in encapsulated form.

### EXAMPLES

### Preparation of Compounds B)

### Example 1

A four-necked round-bottom flask equipped with stirrer, thermometer and reflux condenser was charged with 45.26 g (0.200 mol) 1,6-hexanediol diacrylate (HDDA) and 86.10 g methoxy(polyethlyene glycol)-350 and heated up to 30° C. under nitrogen atmosphere. 40.84 g (0.400 mol) N,N-dimethylaminopropylamine (DMAPA) was added by using a dropping funnel over 20 minutes. The reaction is slightly exothermic and temperature did not exceed 50° C. The mixture was stirred for 3 hours at 50° C. The product obtained was a viscous, orange liquid.

Examples 2 to 3 were prepared analogously, but with different molar ratios, as summarized in Table 1 below.

TABLE 1

| | | | | DMAPA/ | | |
|---|---|---|---|---|---|---|
| Example | HDDA/g | HDDA/mol | DMAPA/g | mol | ratio | appearance |
| 1 | 45.26 | 0.200 | 40.84 | 0.400 | 1/2 | liquid, orange, clear |
| 2 | 45.26 | 0.200 | 30.63 | 0.300 | 2/3 | liquid, yellow, clear |
| 3 | 67.89 | 0.300 | 40.84 | 0.400 | 3/4 | liquid, yellow, clear |

### Example 4

A four-necked round-bottom flask equipped with stirrer, thermometer and reflux condenser was charged with 24.23 g (0.100 mol) dipropylene glycol diacrylate and 44.65 g methoxy(polyethlyene glycol)-350 and heated up to 30° C. under nitrogen atmosphere.

20.42 g (0.200 mol) N, N-dimethylaminopropylamine was added by using a dropping funnel over 20 minutes. The reaction is slightly exothermic and temperature did not exceed 50° C. The mixture was stirred for 3 hours at 50° C. The product obtained was a viscous, yellow liquid.

### Example 5

A four-necked round-bottom flask equipped with stirrer, thermometer and reflux condenser was charged with 30.04 g (0.100 mol) tripropylene glycol diacrylate and 50.46 g methoxy(polyethlyene glycol)-350 and heated up to 30° C. under nitrogen atmosphere.

20.42 g (0.200 mol) N,N-dimethylaminopropylamine was added by using a dropping funnel over 20 minutes. The reaction is slightly exothermic and temperature did not exceed 50° C. The mixture was stirred for 3 hours at 50° C. The product obtained was a viscous, yellow liquid.

### Example 6

A four-necked round-bottom flask equipped with stirrer, thermometer and reflux condenser was charged with 24.23 g (0.050 mol) bisphenol A glycerolate diacrylate and 34.44 g methoxy(polyethlyene glycol)-350 and heated up to 30° C. under nitrogen atmosphere.

10.21 g (0.100 mol) N,N-dimethylaminopropylamine was added by using a dropping funnel over 20 minutes. The reaction is slightly exothermic and temperature did not exceed 50° C. The mixture was stirred for 3 hours at 50° C. The product obtained was a viscous, yellow liquid.

### Example 7

A four-necked round-bottom flask equipped with stirrer, thermometer and reflux condenser was charged with 44.00 g (0.222 mol) butanediol diacrylate and 84.84 g methoxy(polyethlyene glycol)-350 and heated up to 30° C. under nitrogen atmosphere.

40.84 g (0.400 mol) N,N-dimethylaminopropylamine was added by using a dropping funnel over 20 minutes. The reaction is slightly exothermic and temperature did not exceed 50° C. The mixture was stirred for 3 hours at 50° C. The product obtained was a viscous, cloudy liquid.

### Example 8

A four-necked round-bottom flask equipped with stirrer, thermometer and reflux condenser was charged with 21.22 g (0.100 mol) neopentyl glycol diacrylate and 41.66 g methoxy(polyethlyene glycol)-350 and heated up to 30° C. under nitrogen atmosphere.

20.42 g (0.200 mol) N,N-dimethylaminopropylamine was added by using a dropping funnel over 20 minutes. The reaction is slightly exothermic and temperature did not exceed 50° C. The mixture was stirred for 3 hours at 50° C. The product obtained was a viscous, slightly cloudy, colorless liquid.

### Example 9

A four-necked round-bottom flask equipped with stirrer, thermometer and reflux condenser was charged with 22.63 g (0.100 mol) 1,6-hexanediol diacrylate and 45.87 g methoxy(polyethlyene glycol)-350 and heated up to 30° C. under nitrogen atmosphere. 23.24 g (0.200 mol) N,N-diethylethylenediamine was added by using a dropping funnel over 20 minutes. The reaction is slightly exothermic and temperature did not exceed 50° C. The mixture was stirred for 3 hours at 50° C. The product obtained was a viscous, slightly cloudy, colorless liquid.

### Example 10

A four-necked round-bottom flask equipped with stirrer, thermometer and reflux condenser was charged with 22.63 g (0.100 mol) 1,6-hexanediol diacrylate and 60.09 g methoxy(polyethlyene glycol)-350 and heated up to 30° C. under nitrogen atmosphere.

37.46 g (0.200 mol) 3,3′-Iminobis(N,N-dimethylpropylamine) was added by using a dropping funnel over 20 minutes. The reaction is slightly exothermic and temperature did not exceed 50° C. The mixture was stirred for 3 hours at 50° C. The product obtained was a viscous, slightly cloudy, colorless liquid.

### Example 11

A four-necked round-bottom flask equipped with stirrer, thermometer and reflux condenser was charged with 48.60 g (0.15 mol) polyethyleneglycol-200 diacrylate and 76.95 g methoxy(polyethyene glycol)-350 and heated up to 30° C. under nitrogen atmosphere.

31.54 g (0.30 mol) diethanolamine was added by using a dropping funnel over 20 minutes. The mixture was stirred for 3 hours at 40° C. The product obtained was a cloudy liquid.

### Application Examples

### Raw Materials:

TABLE 2

| Name | Description | Manufacturer |
|---|---|---|
| Mowilith LDM | Aqueous copolymer dispersion based on | Celanese Co. |
| 7416 | acrylic and methacrylic acid esters and | |
| | styrene, non-volatile content 50% by | |
| | weight | |
| Texanol | 2,2,4-Trimethyl-1,3- | Eastman Chemical |
| | pentandiolmonoisobutyrat | |
| Tioxide TR-92 | Titanium dioxide | Huntsman GmbH |
| Parmetol A 26 | Chloromethyl-/methylisothiazolone | Schülke & Mayr GmbH |
| | (CMI/MI) and O-formal | |
| BYK ®-018 | VOC-free silicone defoamer | BYK-Chemie GmbH |
| Disperbyk ®-199 | Copolymer with pigment affinic groups | BYK-Chemie GmbH |
| Optigel ® CK | bentonite clay | BYK-Chemie GmbH |
| AMP 90 | 2-amino-2-methyl-1-propanol 90% in | Angus Chemical |
| | water | Company |
| Lupasol P | 50% aqueous solution of branched | BASF |
| | polyethylenimine of molecular weight | |
| | 750000 | |
| Lupasol WF | Polyethylenimine of molecular weight | BASF |
| | 25000 | |
| Epomin SP-003 | Polyethylenimine of molecular weight | Nippon Shokubai |
| | 300 | |

### Test System: Styrene Acrylic White Paint

Production of the styrene acrylic white paint was carried out using the formulation in Table 3. All mill base materials were filled in a double-wall grinding pot and were dispersed under the specified conditions. After dispersing the let-down was added under the condition specified in table 3. Afterwards the adjustment of the pH of the control sample and the clay containing formulation was done using AMP 90 to pH 8.5. Subsequently, the silicate containing formulations were divided for formulation into portions of 70 g in 100 ml glass bottles. Amine functional compounds B) and comparative compounds were added to the portions in an amount of 15% by weight, calculated on the amount of silicate, under stirring with a Dispermat LC3 (VMA Getzmann), 1500 rpm, 2.5 cm diameter toothed plate, 5 minutes at room temperature (23° C.).

After storage at room temperature over night the samples were applied for the sag resistance test with a stepped doctor blade Model 421/S (Erichsen GmbH & Co KG) with 30-300 respectively 50-500 μm wet film thickness. The application was done on contrast cards 2801 (BYK-Gardner GmbH) using the automatic applicator byko-drive XL (BYK-Gardner GmbH) with an application speed of 50 mm/s. For this measurement, the stepped doctor blade is used to apply coating layers of different thicknesses. Between two stripes of different thickness, a defined distance is generated by the doctor blade. If the sag resistance is not acceptable, this leads to a reduced distance between two neighboring coating stripes or—even worse—to the stripes flowing into each other. Other inacceptable results include formation of runners and bulge building. Directly after application, the draw down was hanged up vertically at room temperature until it was dry. After drying the visual evaluation of the sag resistance was done. For this purpose, the highest wet film thickness was considered that shows after drying a clear separation between two neighboring coating stripes, no runner formation, and no bulge building. Beside the application, the viscosity at 0.4 1/s was measured with a rheometer Physica MCR301 (Anton Paar GmbH) using the following parameters: CSR measurement, cone 2.5 cm 1°, Shear rate 0.1-1000 1/s up and down at 23° C. The gloss of the formulations was measured with a mcro-tri gloss (BYK Gardner GmbH) at 60° in the second line of the stepped doctor blade draw down at 100 μm wet film thickness and the visual judgement of the seeding tendency was done in the first line of the stepped doctor blade draw down at 50 μm wet film thickness.

TABLE 3
Styrene acrylic white paint formulation

| | Control | 1.5% Optigel CK |
|---|---|---|
| Mill base | | |
| DI water | 12.1 | 12.1 |
| Disperbyk ®-199 | 0.8 | 0.8 |
| BYK-018 | 0.3 | 0.3 |
| Parmetol A 26 | 0.2 | 0.2 |
| Tioxide TR-92 | 22.0 | 22.0 |
| Optigel ® CK | — | 1.5 |

Dispermat CV, 20° C., 30 min, 8500 rpm,
4.0 cm-diameter toothed plate

| | | |
|---|---|---|
| Let down | | |
| Mowilith LDM 7416 | 63.0 | 63.0 |
| Texanol | 1.6 | 1.6 |
| | 100.0 | 101.5 |

Dispermat CV, 2 min, 1000 rpm,
4.0 cm-diameter toothed plate

TABLE 4
Application results

| | | | | | Viscosity at |
|---|---|---|---|---|---|
| | | Sag | Gloss | Seeds | 0.4 1/s |
| Formulation | | resistance | 60° at | visual at | Upcurve |
| Example | Rheology package | [μm] | 100 μm | 50 μm | [mPas] |
| A* | None | 100 | 74 | no | 1710 |
| B* | 1 (without Optigel CK) | 100 | 73 | no | 1800 |
| C* | Optigel CK | 250 | 61 | no | 45327 |
| | (Reference) | | | | |
| D* | Optigel CK + Lupasol | 350 | 35 | very | 75623 |
| | WF | | | strong | |
| E* | Optigel CK + Lupasol | 400 | 38 | very | 80262 |
| | P | | | strong | |
| F* | Optigel CK + Epomin | 200 | 61 | strong | 37635 |
| | SP003 | | | | |
| G | Optigel CK + 1 | 450 | 59 | no | 137260 |
| H | Optigel CK + 4 | 350 | 60 | no | 69200 |
| I | Optigel CK + 5 | 375 | 64 | no | 72567 |
| J | Optigel CK + 6 | 300 | 62 | no | 57002 |
| K | Optigel CK + 7 | 350 | 61 | no | 92119 |
| L | Optigel CK + 8 | 375 | 64 | no | 76979 |
| M | Optigel CK + 9 | 375 | 61 | no | 91598 |
| N | Optigel CK + 10 | 400 | 65 | no | 84525 |
| O | Optigel CK + 2 | 400 | 59 | no | 129400 |
| P | Optigel CK + 3 | 400 | 60 | no | 140790 |
| Q^{#} | Optigel CK + 2 | 1000 | not | no | 365680 |
| | | | measured | | |
| R^{#} | Optigel CK + 3 | 1000 | not | no | 291860 |
| | | | measured | | |

Comparative Examples in Table 4 are marked by *.

Examples marked with #contain compound B) in an amount of 30% by weight (instead of 15% by weight), calculated on the amount of silicate.

From the Table 4 it is visible that comparative Formulation C that contains only the silicate (Optigel CK) in the absence of compound B and comparative Formulation B that contains only compound B of preparation Example 1 in the absence of the clay show a significantly lower sag resistance and viscosity than the samples that contain the inventive combination of clay and compound B). All compounds B) according to the invention improve the rheological effectiveness of the silicate and therefore increase its efficiency without negative impact on gloss and seeding tendency.

Whereas comparative formulations D and E also improve the rheologic performance of the silicate, they have a strong negative impact on gloss and seeding tendency of the paint. Comparative formulation F reveals less negative impact on gloss, but rheologic improvement is also less pronounced and despite the slight increase in sag resistance, also this comparative formulation has a negative influence on seed formation.

### Test System: Unsaturated Polyester System

### Raw Materials

TABLE 5

| Name | Description | Manufacturer |
|---|---|---|
| Palatal P4-01 | Unsaturated polyester resin | Aliancys A.G. |
| ECOS ND 15 | Cobalt Octoat | Umicore AG & Co. KG |
| Aerosil 200 | Hydrophilic Fumed Silica | Evonik Operations GmbH |

Production of the unsaturated polyester system was carried out using the formulation in table 6. All ingredients were added under stirring conditions into a PE bucket and homogenised with a Dispermat CV (VMA Getzmann), 3100 rpm, 9 cm diameter toothed plate, 15 minutes at room temperature (23° C.). The system was divided into smaller amounts (100 g in 150 ml glass bottles) and the inventive examples were incorporated with a dosage of 20 wt. % of the compound B (calculated on the weight amount of Aerosil 200) under stirring with Dispermat LC3 (VMA Getzmann), 1000 rpm, 2.5 cm diameter toothed plate, 5 minutes at room temperature (23° C.). After storage at room temperature over night the samples were applied for the sag resistance test with a stepped doctor blade Model 421/S (Erichsen GmbH & Co KG) with 50-500 μm wet film thickness. The application was done on contrast cards 2801 (BYK-Gardner GmbH) using the automatic film applicator byko-drive XL (BYK-Gardner GmbH) with an application speed of 50 mm/s. Directly after application, the draw down was hanged up vertically at room temperature until it was dry. After drying the visual evaluation of the sag resistance was done. Therefore, the maximum wet film thickness was considered that shows after drying a clear separation of the draw down, no runners and no bulge building between the applied film thickness.

TABLE 6
Unsaturated polyester system

| | | |
|---|---|---|
| Palatal P4-01 | 74.00 | g |
| ECOS ND 15 | 1.00 | g |
| Aerosil 200 | 2.00 | g |

Dispermat CV, 5 min., 3100 RPM,
9 cm-toothed plate

| | | |
|---|---|---|
| Styrene | 23.00 | g |
| | 100.00 | g |

TABLE 7
Results

| Rheology package | Sag resistance/μm |
|---|---|
| Control (without Aerosil and without compound B) | <50 |
| Reference (only Aerosil 200, no compound B) | 200 |
| Aerosil 200 + Example 1 | 300 |
| Aerosil 200 + Example 2 | 300 |
| Aerosil 200 + Example 3 | 350 |
| Aerosil 200 + Example 11 | 300 |
| Aerosil 200 + Lupasol WF* | 200 |
| Aerosil 200 + Epomin-SP 003* | 250 |

*Also the non-inventive examples Lupasol WF and Epomin-SP 003 were incorporated at 20 wt. % dosage (calculated on the weight amount of Aerosil 200), like the inventive examples.

From table 7 it can be concluded that the inventive rheology additives allow a better sag resistance in the unsaturated polyester formulation than the non-inventive comparative examples.

1. A composition comprising:
a silicate, and
a compound B) having a molecular weight of at least 200 g/mol and comprising at least one ester group and at least two groups selected from secondary amine, tertiary amine, salt of secondary amine, salt of tertiary amine, and quaternary ammonium.

2. The composition according to claim 1, wherein compound B) further comprises ethylenically unsaturated groups in an amount up to 2.0 mmol/g.

3. The composition according to claim 1, wherein compound B) has a molecular weight in the range of 200 to 4000 g/mol.

4. The composition according to claim 1, wherein compound B) comprises at least two tertiary amine groups.

5. The composition according to claim 1, wherein compound B) comprises at least two ester groups.

6. The composition according to claim 1, wherein compound B) is represented by the following formula (I)
R¹—(—O—(C═O)—CR²R³—CR⁴R⁵—NR⁶R⁷ (I)
wherein R¹ represents an organic group having 2 to 300 carbon atoms,
R², R³, R⁴, and R⁵ independent of each other represent hydrogen or an alkyl group having 1 to 6 carbon atoms, with the proviso that at least one of R², R³, R⁴, and R⁵ is hydrogen,
R⁶ and R⁷ independently of each other represent hydrogen or an organic group, wherein at least one of R⁶ and R⁷ is not hydrogen, and wherein at least one of R¹, R⁶, and R⁷ comprise at least one group selected from secondary amine, tertiary amine, salt of secondary amine, salt of tertiary amine, and quaternary ammonium.

7. The composition according to claim 1, wherein the silicate comprises at least one of synthetic clay, natural clay, and silica.

8. The composition according to claim 7, wherein the synthetic clay or the natural clay comprises a smectite, or wherein the silica comprises fumed silica.

9. The composition according to claim 1, wherein compound B) is present in an amount of 3.0 to 100.0% by weight, calculated on the weight of the silicate.

10. An aqueous liquid composition comprising water and the composition according to claim 1.

11. The aqueous liquid composition according to claim 10, further comprising a film-forming binder.

12. The aqueous liquid composition according to claim 11, wherein the film-forming binder comprises at least one of polyacrylate, copolymer of styrene, polyvinylester, polyurethane, polyester, polyunsaturated resin, and epoxide resin.

13. The aqueous liquid composition according to claim 10, wherein the aqueous liquid composition comprises the silicate in the range of 0.10 to 7.00% by weight, calculated on the weight of the aqueous liquid composition.

14. A coating composition comprising a pigment and the aqueous liquid composition according to claim 10.

15. A process of coating a substrate with at least one coating layer, the process comprising applying an aqueous liquid composition to a substrate,
the aqueous liquid composition comprising:
water,
a silicate, and
a compound B) having a molecular weight of at least 200 g/mol and comprising at least one ester group and at least two groups selected from secondary amine, tertiary amine, salt of secondary amine, salt of tertiary amine, and quaternary ammonium.

16. (canceled)

17. The composition according to claim 1, wherein compound B) comprises no ethylenically unsaturated groups.

18. The composition according to claim 1, wherein compound B) is present in an amount of 5.0 to 60.0% by weight, calculated on the weight of the silicate.

19. A process of increasing viscosity of an aqueous composition comprising a silicate, the process comprising adding a compound B) to the aqueous composition, the compound B) having a molecular weight of at least 200 g/mol and comprising at least one ester group and at least two groups selected from secondary amine, tertiary amine, salt of secondary amine, salt of tertiary amine, and quaternary ammonium.
